(19) United States
(12) Patent Application Publication
(10) Pub. No.: US 2023/0292667 A1
(43) Pub. Date: Sep. 21, 2023

(54) MOWER

(71) Applicant: HONDA MOTOR CO., LTD., Tokyo (JP)

(72) Inventors: Noboru Kawaguchi, Wako-shi (JP); Shohei Masuda, Wako-shi (JP); Takuya Mito, Wako-shi (JP); Kenichi Toya, Wako-shi (JP); Sei Watanabe, Wako-shi (JP)

(73) Assignee: HONDA MOTOR CO., LTD., Tokyo (JP)

(21) Appl. No.: 18/116,479

(22) Filed: Mar. 2, 2023

(30) Foreign Application Priority Data
Mar. 18, 2022 (JP) 2022-044245

(51) Int. Cl. A01D 43/08; A01D 43/063; A01D 43/00

(52) U.S. Cl. CPC A01D 43/086; A01D 43/063; A01D 43/003

(57) ABSTRACT

A mower (1) comprising: a blade (9) that mows grass; a power generation unit (5) that generates a driving force for rotating the blade (9); a housing (7) that covers the blade (9); and a milling unit (10) that subdivides grass mowed by the blade and discharged from the housing (7).

### CROSS-REFERENCE TO RELATED APPLICATION(S)

This application claims priority to and the benefit of Japanese Patent Application No. 2022-044245 filed on Mar. 18, 2022, the entire disclosure of which is incorporated herein by reference.

### BACKGROUND OF THE INVENTION

### Field of the invention

The present invention relates to a mower.

### Description of the Related Art

Conventionally, there has been known a mower that includes a blade that is attached so as to be rotatable, a body having a housing that accommodates a cutter blade, and a grass bag, and discharges grass mowed by the blade from the housing (Japanese Patent Laid-Open No. 2020-156447).

As a conventional problem, when the grass hag becomes full in a short time during mowing, it is necessary for the user to frequently discard mowed grass accommodated in the grass bag, which is troublesome. In addition, composting or bio-gasification of mowed grass takes time, and there is room for improvement in utilizing the mowed grass as a recycled resource.

### SUMMARY OF THE INVENTION

The present invention has been made in consideration of the above described backgrounds and realizes a mower that can reduce the volume and weight of mowed grass to decrease the frequency of mowed grass disposal, thereby reducing the workload of the user.

In order to solve the above described backgrounds, according to the first aspect of the present invention, there is provided a mower (1) comprising: a blade (9) that mows grass; a power generation unit (5) that generates a driving force for rotating the blade (9); a housing (7) that covers the blade (9); and a milling unit (10) that subdivides grass mowed by the blade and discharged from the housing (7).

According to the second aspect of the present invention, in the first aspect, the mower (1) further comprises an accommodation unit (8) that accommodates the mowed grass subdivided by the milling unit (10).

According to the third aspect of the present invention, in the second aspect, the accommodation unit (8) includes a separation unit (14) that separates moisture discharged from the mowed grass subdivided by the milling unit (10) from the subdivided grass.

According to the fourth aspect of the present invention, in the third aspect, the mower (1) further comprises a storage unit (20) that stores the moisture separated from the mowed grass by the separation unit (14).

According to the fifth aspect of the present invention, in one of the first to fourth aspect, the mower (1) further comprises a power transmission unit (15, 17) that transmits a driving force generated by the power generation unit (5) to the milling unit (10).

According to the sixth aspect of the present invention, in one of the first to fourth aspect, the mower (1) further comprises a power transmission unit (17) that transmits a driving force generated by rotation of a wheel (4) of the mower to the milling unit (10).

According to the seventh or eighth aspect of the present invention, in the fifth or sixth aspect, the milling unit (10) includes a pair of rollers (11, 12) that rotate while being in contact with each other to grind mowed grass, and the power transmission unit (15, 17) transmits e driving force to the rollers (11, 12) to rotate the pair of rollers (11, 12).

According to the present invention, the volume and weight of named grass can be reduced to decrease the frequency of mowed grass disposal, thereby reducing the workload of the user.

Specifically, according to the first aspect of the present invention, the mowed grass is subdivided, thereby shortening the time until the decomposition of the mowed grass, increasing the effectiveness of mulching, or facilitating reuse as a material.

According to the second aspect of the present invention, the subdivided mowed grass accommodated in the accommodation unit (8) can be reused as a recycled material.

According to the third aspect of the present invention, nutrient components contained in moisture can be reduced to a grass field (lawn). In addition, with no moisture being accumulated in the accommodation unit (8), the weight of the mowed grass accumulated in the accommodation unit (8) is reduced at the time of disposal, so that the workload of the user can be reduced.

According to the fourth aspect of the present invention, the storage unit (20) is made detachable, and a faucet 21 or the like is provided, so that the user can supply the stored moisture to dry ground, a plant in need of moisture, or the like as necessary.

According to the fifth aspect of the present invention, the blade (9) and the power source are shared, so that there is no need to provide a dedicated power generation unit in the milling unit (10), which can reduce the number of parts.

According to the sixth aspect of the present invention, by operating the milling unit (10) by the rotation of the wheels (4), there is no need to provide a dedicated power generation unit in the milling unit (10), which can reduce energy consumption.

According to the seventh aspect of the present invention, the milling unit (10) can be configured simply and inexpensively.

Further features of the present invention will become apparent from the following description of exemplary embodiments with reference to the attached drawings).

### BRIEF DESCRIPTION OF THE DRAWINGS

FIG. 1 is an external view of a lawn mower according to the present embodiment;

FIGS. 2A to 2C are cross-sectional views schematically illustrating a configuration of a mill mechanism according to the present embodiment;

FIGS. 3A and 3B are cross-sectional views schematically illustrating a configuration in which a separation mechanism is provided in the mill mechanism according to the present embodiment; and

FIGS. 4A to 4C are cross-sectional views schematically illustrating the driving system of the mill mechanism according to the present embodiment.

### DESCRIPTION OF THE EMBODIMENTS

Hereinafter, embodiments will be described in detail with reference to the attached drawings. Note that the following embodiments are not intended to limit the scope of the claimed invention, and limitation is not made an invention that requires all combinations of features described in the embodiments. Two or more of the multiple features described in the embodiments may be combined as appropriate. Furthermore, the same reference numerals are given to the same or similar configurations, and redundant description thereof is omitted.

Hereinafter, an embodiment in which the mower of the present invention is applied to a lawn mower for mowing weeds, lawns, and the like will be described. Note that the present invention is not limited to a lawn mower but is also applicable to an outdoor cleaner that vacuums fallen leaves and the like.

In the following description, the front, rear, left, right, up, and down directions of the lawn mower are F, R, L, R, LI, and D, respectively, in accordance with the direction as viewed from the user.

### Lawn Mower

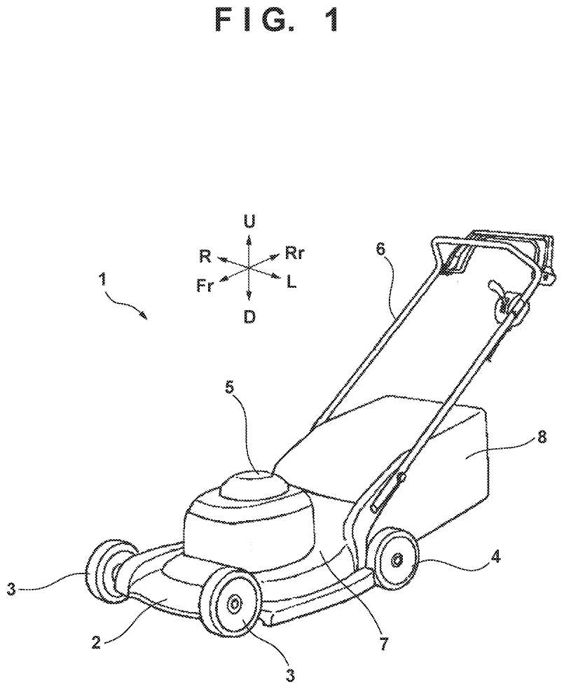

FIG. 1 is an external view of a lawn mower according to the present embodiment.

A lawn mower 1 according to the present embodiment includes a body 2. left and right front wheels 3 provided on both front ends of the body 2 so as to be rotatable, left and right rear wheels 4 rotatably provided on both rear ends of the body 2 so as to be rotatable, a power generation unit 5 provided on the upper surface of the body 2, and a handle 6 extending rearward and upward from a rear end of the body 2. The lawn mower I is a walking lawn mower that can be moved to any place by a user operating the handle 6. The power generation unit 5 is an engine or a motor, or a combination (hybrid) of an engine and a motor. Further, the power generation unit 5 includes a battery (not illustrated) as a power supply unit. When the power generation unit .5 is an engine, the battery is charged with power generated by an alternator (generator) driven by the engine. In addition, when the power generation unit 5 is a motor, the battery is charged with power supplied from an external power source.

The body 2 has a disk shape that opens downward and has an outer shape formed by a housing 7 that accommodates a blade (not illustrated). A grass bag 8 is connected to the rear end of the body 2. The grass bag 8 constitutes an accommodation unit that accommodates the grass mowed by the blade.

### Mill Mechanism

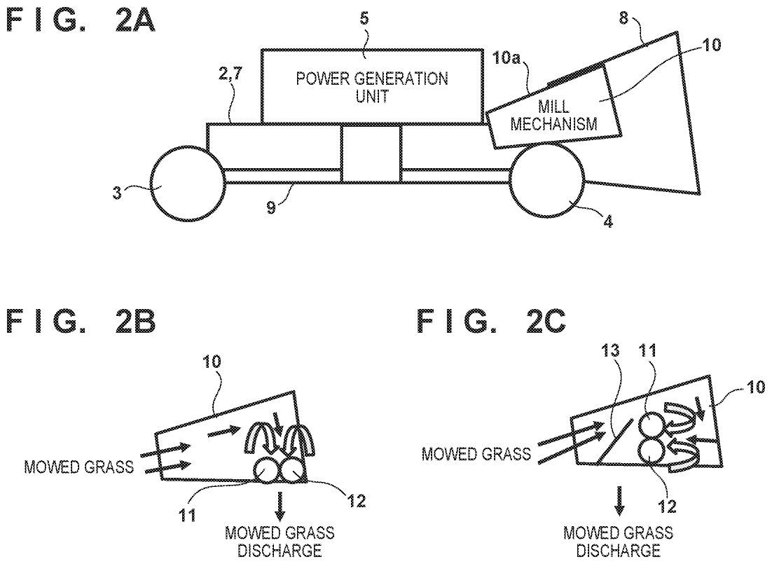

FIGS. 2A to 2C are cross-sectional views schematically illustrating the configuration of the mill mechanism mounted on the lawn mower according to the present embodiment.

In the lawn mower 1 according to the present embodiment, a mill mechanism 10 is provided inside the grass bag S. The mill mechanism 10 is disposed on the upstream side adjacent to the body 2 in the grass bag 8.

The grass mowed by a blade 9 is pushed from the housing 7 of the body 2 into the mill mechanism 10 of the grass bag 8 by a swirling flow generated by the rotation of the blade 9.

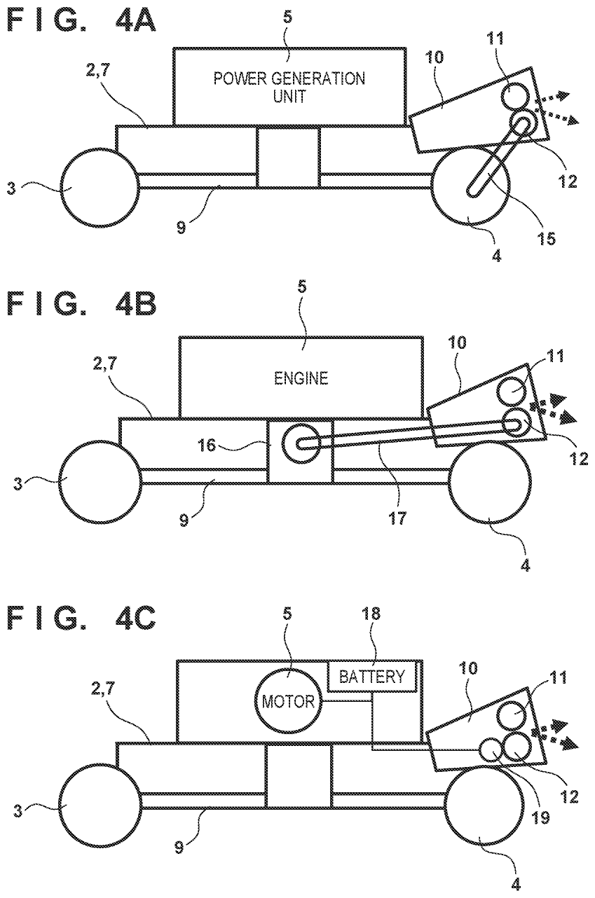

As illustrated in FIG, 2A, the mill mechanism 10 has a pair of rollers 11, 12 and rotationally drives the rollers 11, 12 by a driving method described later in FIGS. 4A to 4C to subdivide the mowed grass, and the grass bag 8 accommodates the mowed grass subdivided by the mill mechanism 10.

The rollers 11, 12 are disposed to rotate while being in contact with each other with a predetermined pressing force in the horizontal direction (front-and-rear direction) illustrated in FIG. 2B or in the vertical direction (up-and-down direction) illustrated in FIG. 2C. Thus, moisture is squeezed out from the mowed grass to remove the moisture. Further, the rollers 11, 12 may be disposed such that, as illustrated in FIG. 2B, the plane including the rotation shafts of the rollers 11, 12 provided horizontally parallel to each other and the line of contact between the rollers 11, 12 is inclined with respect to the vertical direction, or such that one end of the rotation shaft is located above the other end. Similarly, the rollers 11, 12 may be disposed such that, as shown in FIG. 2C, the plane including the rotation shafts of the rollers 11, 12 provided vertically parallel to each other and the line of contact between the rollers 11, 12 is inclined with respect to the horizontal direction, or such that one end of the rotation shaft is located forward or rearward from the other end.

Further, the rollers 11, 12 have a function of crushing and subdividing mowed grass and grinding the mowed grass into a powder form or a paste form by rotating in a state where the surfaces machined to a predetermined roughness are in contact with each other. This enables the mill mechanism 10 to be configured simply and inexpensively. Note that in this case, it is possible to enhance the function of grinding the mowed grass by making a rotation speed difference between the rollers 11, 12. In addition, the rollers 11, 12 may be provided with protrusions having a gear-like shape or a twisted gear-like shape on the surface, whereby the mowed grass is always pushed out in one direction, making it easier

In the configuration (FIG. 2B) where the rollers 11, 12 are disposed in the horizontal direction (front-and-rear direction) at the lower rear end of a housing 10a, of the mill mechanism 10, the mowed grass pushed by the swirling flow of the blade 9 can be naturally dropped due to its own weight and put into the rollers 11, 12, which makes a simpler configuration possible.

Further, in the configuration where the rollers 11, 12 are disposed in the vertical direction (up-and-down direction) at the lower rear end of the housing 10a of the mill mechanism 10 (FIG. 2C), the mowed grass pushed in by the swirling flow of the blade 9 is forcibly moved to the upper rear end of the mill mechanism by a guide plate 13 disposed as inclined rearward and upward on the upstream side of the rollers 11, 12, and the mowed grass naturally falling due to its own weight can be sequentially pulled in by the rotating rollers 11, 12. In this case, the guide plate 13 has a function of partitioning unprocessed mowed grass that is newly pushed into the mill mechanism 10 and mowed grass having been processed by the mill mechanism 10 such that the unprocessed mowed grass and the processed mowed grass are not mixed.

The mowed grass ground by the rollers 11, 12 and the moisture squeezed out are discharged from the housing 10a of the mill mechanism 10 to the inside of the grass bag 8.

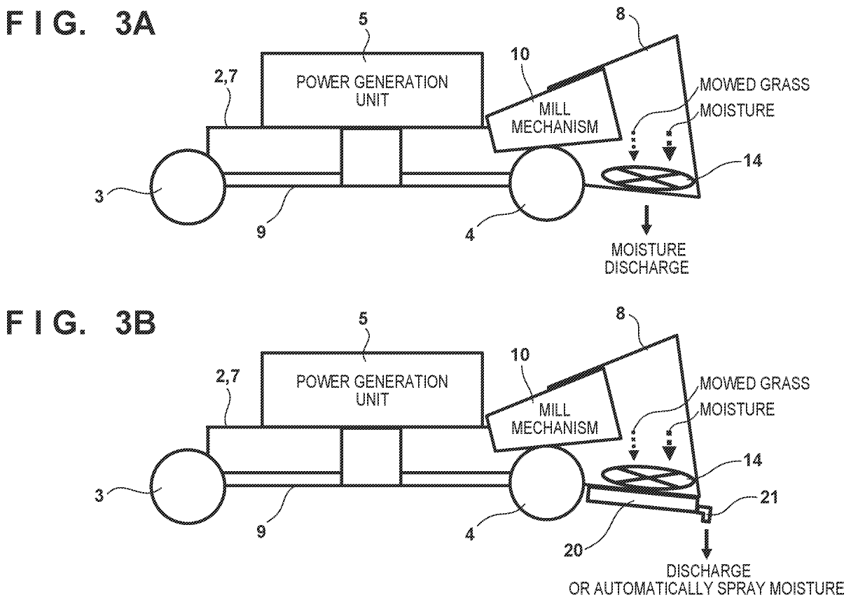

FIGS. 3A and 3B are cross-sectional views illustrating a configuration example in which a separation mechanism for separating mowed grass and moisture is provided in the mill mechanism according to the present embodiment.

A separation mechanism 14 includes a mesh having a predetermined roughness or a squeezing roller and separates the mowed grass processed by the mill mechanism 10 from moisture.

As illustrated in FIG. 3A, the separation mechanism 14 is disposed at the lower rear end of the grass bag 8. The separation mechanist 14 can separate only moisture while causing the named grass processed by the mill mechanism 10 and moisture to naturally fall due to its own weight, and discharge the moisture to the outside of the grass bag 8.

Further, the nutritional components contained in the moisture separated by the separation mechanism 14 can be reduced to the lawn. In addition, with no moisture being accumulated in the grass bag 8, the weight of the mowed grass accumulated in the grass bag 8 is reduced at the time of disposal, so that the workload of the user can be reduced.

Further, as illustrated in FIG. 3B, it is possible to improve convenience by providing a tank 20 that collects and stores moisture after separation by the separation mechanism 14 in a lower portion of the grass bag 8 (or the body 2). In the example of FIG. 3B, the tank 20 is configured to be detachable from the body 2, and a faucet 21 or the like is provided in the tank 20, so that the user can supply moisture stored in the tank 20 to dry ground, a plant in need of moisture, or the like as necessary. Alternatively, the body 2 or the grass bag 8 may be provided with a sensor for detecting dry ground, a plant in need of moisture, or the like, and the faucet 21 may be automatically opened to automatically spray moisture in accordance with a detection result of the sensor.

FIGS. 4A to 4C are cross-sectional views schematically illustrating a configuration example of a driving system of the mill mechanism according to the present embodiment.

FIG. 4A illustrates a configuration example of a first driving system of the mill mechanism according to the present embodiment.

In the first driving system, the driving force generated by the rotation of the rear wheels 4 is transmitted to the mill. mechanism 10 by the power transmission mechanism 15 such as a belt to drive the rollers 11, 12.

According to the first driving system, by operating the mill mechanism 10 by the rotation of the rear wheels 4, there is no need to prepare a dedicated power source in the mill mechanism 10, which can reduce energy consumption amount.

FIG. 4B illustrates a configuration example of a second driving system of the mill mechanism according to the present embodiment.

In the second driving system, the driving force generated by the rotation of the output shaft 16 of the engine as the driving source 5 is transmitted to the mill mechanism 10 by the power transmission mechanism 17 such as a belt, and the rollers 11, 12 are driven. The mill mechanism 10 may be provided with a roller driving motor for driving the rollers 11, 12, and instead of the driving force of the engine, power generated by an alternator (generator) driven by the engine may be supplied to the roller driving motor to drive the rollers 11, 12.

According to the second driving system, the blade 9 and the power source are shared, so that there is no need to prepare a dedicated power source in the mill mechanism 10, which can reduce the number of parts.

Note that in the second driving system, a roller driving motor for driving the rollers 11, 12 may be provided in the mill mechanism 10, and the roller driving motor may be driven by power generated by an alternator (generator) driven by an engine.

FIG. 4C illustrates a configuration example of a third driving system of the mill mechanism according to the present embodiment.

In the third driving system, the rollers 11, 12 are driven using the power of the battery 18 that supplies power to the motor as the driving source 5. In this case, a roller driving motor 19 for driving the rollers 11, 12 is provided in the mill mechanism 10, and the power of the battery 18 is supplied to the roller driving motor 19 to drive the rollers 11, 12.

According to the third driving system, the blade 9 and the power source are shared, so that there is no need to prepare a dedicated power source in the mill mechanism 10, which can reduce the number of parts.

Note that in the third driving system, the user may turn on and off the operation of the mill mechanism 10 at any timing.

Note that in the first, second, and third driving systems, either one of the rollers 11, 12 may be a driving wheel and the other may be a driven wheel, or both the rollers may be driven. In addition, when the driving mechanism of the mill mechanism 10 and the power source can be separated, the mill mechanism 10 may be configured to be detachable from the grass bag 8.

As described above, according to the present embodiment, most of the mowed grass is moisture, but moisture can be reduced from the mowed grass. Thus, the volume and weight of the mowed grass can be reduced to decrease the frequency of discarding the mowed grass contained in the grass bag 8, thereby reducing the workload of the user.

Further, the mowed grass is subdivided, thereby shortening the time until the decomposition of the mowed grass, increasing the effectiveness of mulching, or facilitating reuse as a material.

Moreover, with the subdivided mowed grass being accommodated in the grass bag 8, there is no need to collect the mowed grass after lawn mowing, which reduces the burden on the user and at the same time eliminates the loss of the aesthetic appearance of the lawn surface due to the mowed grass. In addition, the subdivided mowed grass contained in the grass bag 8 can be reused as a recycled material.

The invention is not limited to the foregoing embodiments, and various variations/changes are possible within the spirit of the invention. For example, in the present embodiment, an example in which the present invention is applied to a walking lawn mower has been described, but the present invention is not limited thereto, and the present invention can also be applied to a robot lawn mower (mower) and a riding lawn mower over).

What is claimed is:

1. A mower comprising:
a blade that mows grass;
a power generation unit that generates a driving force for rotating the blade;
a housing that covers the blade; and
a milling unit that subdivides grass mowed by the blade and discharged from the housing.

2. The mower according to claim 1, further comprising
an accommodation unit that accommodates the mowed grass subdivided by the milling unit.

3. The mower according to claim 2, wherein
the accommodation unit includes a separation unit that separates moisture discharged from the mowed grass subdivided by the milling unit from the subdivided grass.

4. The mower according to claim 3, further comprising
a storage unit that stores the moisture separated from the mowed grass by the separation unit.

5. The mower according to claim 1, further comprising
a power transmission unit that transmits a driving force generated by the power generation unit to the milling unit.

6. The mower according to claim 1, further comprising
a power transmission unit that transmits a driving force generated by rotation of a wheel of the mower to the milling unit.

7. The mower according to claim 5, wherein
the milling unit includes a pair of rollers that rotate while being in contact with each other to grind mowed grass, and
the power transmission unit transmits the driving force to the rollers to rotate the pair of rollers.

8. The mower according to claim 6, wherein
the milling unit includes a pair of rollers that rotate while being in contact with each other to grind mowed grass, and
the power transmission unit transmits the driving force to the rollers to rotate the pair of rollers.
